(19) United States
(12) Patent Application Publication
(10) Pub. No.: US 2018/0133099 A1
(43) Pub. Date: May 17, 2018

(54) FOOT CARE PRODUCTS AND METHODS OF USE

(71) Applicant: SONIPED, LLC, Salt Lake City, UT (US)

(72) Inventors: Jason Wade, Salt Lake City, UT (US); Steven Derrick Porter, Salt Lake City, UT (US); Logan Mills Woolley, Salt Lake City, UT (US)

(21) Appl. No.: 15/563,505

(22) PCT Filed: Nov. 10, 2015
(86) PCT No.: PCT/US2015/059913

§ 371 Date: Sep. 29, 2017

Related U.S. Application Data
(60) Provisional application No. 62/078,789, filed on Nov. 12, 2014.
(60) Provisional application No. 62/120,033, filed on Feb. 24, 2015.

(51) Int. Cl. A61H 23/02

(52) U.S. Cl. CPC A61H 23/02; A61H 2201/0111; A61H 2203/0406; A61H 2201/0115; A61H 2205/12; A61H 2201/164; A61H 2201/013; A61H 2201/0107; A61H 2201/0165

(57) ABSTRACT

Foot care devices include a battery-powered vibration motor disposed inside a water-tight housing, a foot treatment element attached to the upper surface of the housing, and surface immobilizing suction cups attached to the bottom of the housing to inhibit positional movement of the device during use. Foot treatment elements have exfoliating pumice, massaging protuberances, and/or cleaning bristles and vibrate during operation of the motor. Cushioning pads between the upper surface of the housing and the attached foot treatment element reduce rattling noises during operation of the motor. Foot treatment elements also have drain holes extending therethrough and the housing has a drain channel for draining water off the upper surface. The devices can also have one or more stabilizing platform extending therefrom. Foot pressure applied to the platform during operation further reduces positional movement. Foot care kits can have a plurality of interchangeable foot treatment elements.

### BACKGROUND

### Technical Field

The present disclosure relates generally to foot care products, and more specifically to electric, vibrating, and/or hands-free foot care devices and methods of using the same. In particular, present disclosure relates a substantially, positionally immobilizable, hands-free, and/or vibrating foot care device.

### Related Technology

Foot care includes cleaning, washing, scrubbing, exfoliating, massaging, deodorizing, and otherwise treating the feet. Foot care, as an industry, occupies a unique space in the economy of developed countries. Pedicures, in particular, are offered as one of a number of luxury spa services that can cost recipients hundreds of dollars per treatment.

Recent trends in foot care include foot care products and devices for at-home or personal use. Such products and devices may provide the convenience of on-demand foot care and cost savings associated with do-it-yourself services. However, existing personal foot care products often fail to reach the level of convenience, performance, and value expected by consumers; even given the reduced cost of purchasing such products and devices. For instance, some existing foot care devices require a small, foot-sized tub of water to be filled prior to each use. In such systems, water can slosh and spill on the floor surrounding the tub.

Other products include hand-held foot-scrubbing devices for cleaning or exfoliating large surfaces of the feet. Such devices inconveniently require the use of hands in caring for feet. Likewise, a user must either sit down and scrub the feet or stand and try to balance long enough to perform the same. This can be especially problematic in the shower and other surfaces where water on the floor may cause the user to slip and fall. Existing hands-free devices require the user to exert substantial effort sliding, twisting, and grinding their feet against product. In addition, existing devices may be subject to water or water-related damage, such as warping, mildew formation, etc.

Accordingly, there are a number of disadvantages in conventional foot care devices and products that can be addressed. Thus, there is a continuing need for a personal foot care device configured for at-home, in-shower use and/or that provides surface stability, hands-free use, and thorough cleaning of all areas of the feet and toes, without the cost associated with luxury spa treatment services.

### BRIEF SUMMARY

Implementations of the present disclosure overcome or solve one or more of the foregoing or other problems in the art with foot care devices having a movement-generating element, a foot treatment element connected to the movement-generating element, and/or a surface-stabilizing and/or immobilizing element connected to the foot treatment element. For instance, an implementation can include a foot care device comprising a vibrating body having one or more suction or friction members connected to a bottom surface thereof and a foot treatment element connected to a top surface thereof. The vibrating body can comprise a housing connected to a base plate, with a battery-powered (vibration) motor disposed in the housing or a cavity thereof. It will be appreciated, however, that certain implementations need not include a movement-generating element or vibrating body. Instead, the device can comprise a non-electric and/or stationary device.

The foot treatment element can be removably attached to the upper surface of the housing and can have exfoliating pumice, massaging protuberances, and/or cleaning bristles (e.g., that vibrate during operation of the motor). The base can have or comprise one or more surface stabilizing platforms that extend outward relative to the housing and/or suction or friction members that secure the base to a surface. Alternatively, an immobilizing element can be connected to the bottom surface of the base, the immobilizing element having or comprising the surface stabilizing platforms and/or surface immobilizing suction or friction members. Certain implementations include kits with replaceable foot treatment elements and/or methods of treating feet with a foot care device or kit of the present disclosure.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of embodiments of the present disclosure can be obtained, a more particular description of the embodiments briefly described above will be rendered by reference to the specific embodiments, which are illustrated in the appended drawings. Understanding that these drawings depict only typical embodiments of the present disclosure and are not therefore to be considered to be limiting of the scope of the invention, the embodiments will be described and explained with additional specificity and detail through the use of the accompanying drawings in which:

FIG. 1A illustrates a front perspective view of an exemplary foot care device in accordance with an implementation of the present disclosure;

FIG. 1B illustrates an exploded view thereof;

FIG. 2 illustrates a bottom exploded view of an assembly thereof:

FIG. 3A illustrates a bottom exploded view of a body portion thereof;

FIG. 3B illustrates a top exploded view of the body portion;

FIG. 4 illustrates a perspective view of various components of a foot care kit in accordance with an implementation of the present disclosure;

FIG. 5 illustrates a bottom exploded view of an assembly in accordance with another implementation of the present disclosure;

FIG. 6 illustrates a front perspective view of an exemplary foot care device in accordance with another implementation of the present disclosure;

FIG. 7A illustrates a top perspective view of an assembly in accordance with another implementation of the present disclosure;

FIG. 7B illustrates a bottom perspective view thereof:

FIG. 7C illustrates a top partial exploded view thereof;

FIG. 7D illustrates a bottom partial exploded view thereof;

FIG. 7E illustrates a further exploded view thereof;

FIG. 8A illustrates a top perspective view of an assembly in accordance with yet another implementation of the present disclosure; and

FIG. 8B illustrates a top partial exploded view thereof.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments, and is not necessarily intended to limit the scope of the claimed invention.

Unless defined otherwise, all technical and scientific terms used herein have the same meaning as commonly understood by one of ordinary skill in the art to which the present disclosure pertains.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” and “involves.” “contains.” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

It will be noted that, as used in this specification and the appended claims, the singular forms “a,” “an” and “the” include plural referents unless the context clearly dictates otherwise. Thus, for example, reference to a “bristle” includes one, two, or more bristles. Similarly, reference to a plurality of referents should be interpreted as comprising a single referent and/or a plurality of referents unless the content and/or context clearly dictate otherwise. Thus, reference to “bristles” does not necessarily require a plurality of such bristles. Instead, it will be appreciated that independent of conjugation; one or more bristles are contemplated herein.

As used herein, directional terms, such as “top,” “bottom,” “left,” “right,” “up,” “down,” “upper,” “lower,” “proximal,” “distal” and the like are used herein solely to indicate relative directions and are not otherwise intended to limit the scope of the disclosure and/or claimed invention.

Various aspects of the present disclosure can be illustrated by describing components that are bound, coupled, attached, connected, and/or joined together. As used herein, the terms “bound,” “coupled”. “attached”, “connected,” and/or “joined” are used to indicate either a direct association between two components or, where appropriate, an indirect association with one another through intervening or intermediate components. In contrast, when a component is referred to as being “directly bound,” “directly coupled”, “directly attached”, “directly connected,” and/or “directly joined” to another component, no intervening elements are present or contemplated. Furthermore, binding, coupling, attaching, connecting, and/or joining can comprise mechanical and/or chemical association.

To facilitate understanding, like reference numerals (i.e., like numbering of components and/or elements) have been used, where possible, to designate like elements common to the figures. Specifically, in the exemplary embodiments illustrated in the figures, like structures, or structures with like functions, will be provided with similar reference designations, where possible. Specific language will be used herein to describe the exemplary embodiments. Nevertheless it will be understood that no limitation of the scope of the disclosure is thereby intended. Rather, it is to be understood that the language used to describe the exemplary embodiments is illustrative only and is not to be construed as limiting the scope of the disclosure (unless such language is expressly described herein as essential). Furthermore, multiple instances of an element and or sub-elements of a parent element may each include separate letters appended to the element number. Furthermore, an element label with an appended letter can be used to designate an alternative design, structure, function, implementation, and/or embodiment of an element or feature without an appended letter. Likewise, an element label with an appended letter can be used to indicate a sub-element of a parent element. However, element labels including an appended letter are not meant to be limited to the specific and/or particular embodiment(s) in which they are illustrated. In other words, reference to a specific feature in relation to one embodiment should not be construed as being limited to applications only within said embodiment.

It will also be appreciated that where multiple possibilities of values or a range of values (e.g., less than, greater than, at least, or up to a certain value, or between two recited values) is disclosed or recited, any specific value or range of values falling within the disclosed range of values is likewise disclosed and contemplated herein.

The headings used herein are for organizational purposes only and are not meant to be used to limit the scope of the description or the claims.

The present disclosure extends to foot care or treatment devices or kits, and to methods of using the same. In particular, certain embodiments include a surface-securable and/or positionally immobilizable foot treatment device. Certain embodiments can have or include vibration or other localized movement functionality. The foot care device can be configured for personal, at-home, hands-free, and/or one-touch vibrating use or operation. The foot care device can be configured for use in or around water or other liquids (e.g., for use in the shower, bathtub, spa, hot tub, swimming pool, etc.). For instance, the foot care device can be water-tight, water-proof, and/or submergible (i.e., operational while submerged in liquid). In addition, the foot care device can have a hands-free and/or foot-operable configuration. For instance, the foot care device can be (wet or dry) surface adherable (or securable), substantially (positionally) immobilizable, and/or foot-engageable. Certain implementations comprise a kit that includes a foot treatment device with replaceable foot treatment elements. Implementations also include methods of treating feet with a foot care device or kit of the present disclosure.

Certain embodiments of a foot care device can generally include a movement-generating element, a foot treatment element, and one or more movement-inhibiting elements. The foot treatment element can be connected to the movement-generating element such that operation of the movement-generating element causes localized movement of the foot treatment element. The movement-inhibiting element can comprise a surface-stabilizing element and/or a surface immobilizing element, and can also be connected to the foot treatment element and/or movement-generating element to substantially inhibit positional movement of the foot treatment element. For instance, the foot care device can include a selectively engageable vibrating body having one or more suction and/or friction members connected to a bottom surface thereof and a foot treatment element connected to a top surface thereof. The device can also include one or more surface-stabilizing foot platforms extending outwardly from the vibrating body.

### Movement-Generating Elements

The movement-generating element can comprise a localized movement-generating mechanism. The movement-generating mechanism can comprise a vibrating member, electric or other motor, or any other suitable mechanism for generating and/or producing a massaging, vibrating, or other form of movement. As used herein, reference to a specific mechanism for producing movement, such as by means of a motor, includes a reference to other mechanism for producing movement. Illustratively, the motor can be or comprise a vibration motor, an oscillating motor, a reciprocating motor, etc. Accordingly, the movement-generating element and/or motor (thereof) can create, produce, and/or effectuate localized movement. As used herein. “localized” movement and similar terms refer to movement within a defined range of motion and/or general, positional location. Accordingly, while localized movement is detectable on a micro scale, the macro movement and/or average positional location may remain substantially constant.

The movement-generating element and/or motor can be battery operated in some embodiments. Accordingly, the movement-generating element can comprise a battery element. The battery element can be electrically coupled and/or connected to the motor. The one or more batteries can be replaceable, rechargeable, alkaline, lithium ion, induction-charged, and/or other types of batteries. The movement-generating element can also comprise a means for (selectively) operating the motor. Such means can include an engaging element, such as an on switch, on-off switch, slidable (and/or variable) switch, push button, dial, knob, or wheel, and/or any other suitable operating mechanism.

In at least one embodiment, the movement-generating element can comprise a vibrating body. As used herein, reference to a specific form of movement, such as a vibration or vibrating, includes a direct reference to other types of movement, including oscillating, reciprocating, etc. Thus, reference to a vibrating body includes other types of moving bodies, including oscillating bodies, reciprocating bodies, etc. The vibrating body can comprise a housing having an encircling wall that at least partially bounds a (water-tight and/or water-proof) cavity. The cavity can have a cavity opening, and the motor and/or battery can be secured to and/or disposed at least partially within the cavity or the interior surface thereof.

In at least one embodiment, the motor and/or battery can be housed within the housing and/or (water-proof) cavity (e.g., such that the motor is operable (and not exposed to liquid) while the body and/or housing is submerged in the liquid. For instance, some embodiments can include a covering element to cover and/or substantially seal the cavity and/or cavity opening thereof. In at least one embodiment, the covering element can comprise a base (plate) attached to the housing (e.g., at a lower edge surface thereof). In some embodiments, the motor can be connected to the upper surface of the base.

The base can have an upper surface attached to the housing to cover the opening, and a lower surface opposite the upper surface (e.g., separated by a base height). In certain embodiments, the base plate can be reversibly attached or secured to the housing and/or lower edge surface thereof. In other embodiments, however, the base plate can be adhered, welded, and/or formed to the housing and/or lower edge surface thereof. Some embodiments can also include a sealing element, such as a (polymeric and/or waterproof) gasket, o-ring, seal, etc. The sealing element can be disposed at least partially between the covering element and the housing (e.g., to create a water-tight and/or sealed cavity. For instance, in certain embodiments, the base and/or housing can include a groove for seating the sealing element therein.

In at least one embodiment, the motor and/or one or more batteries can be disposed inside a water-tight, water-proof, and/or water-resistant chamber (or other environment) within the cavity. In some embodiments, the housing and/or wall thereof can include a removable face (plate) or covering for accessing the motor and/or battery. The cover can seal and/or secure the motor and/or one or more batteries in the chamber (e.g., such that the motor and/or one or more batteries not exposed to liquid while the body is submerged in the liquid.

In some embodiments, the body, housing, wall, and/or an exterior surface thereof can include an upper receiving area. The receiving area and/or an upper treatment surface thereof can comprise a generally, substantially, and/or at least partially recessed or concave surface and/or configuration. For instance, the surface and/or configuration can be U-shaped and/or comprise a bottom surface and two side walls or surfaces (e.g., extending vertically upward from the bottom surface). The side walls can slope (gradually) or can have a sharp and/or angled configuration. Alternatively, the generally, substantially, and/or at least partially concave surface and/or configuration can be J-shaped, L-shaped configuration (e.g., with only one side wall), etc.

The movement-generating element or body, housing, wall, exterior surface, and/or receiving area thereof, can have one or more foot treatment elements connected thereto and/or extending therefrom and/or an attachment element for securing the foot treatment element thereto. For instance, the attachment element can comprise one or more sockets for receiving attachment posts extending from the foot treatment element. The socket and post configuration can produce a substantially secured, reversibly attachable connection in certain embodiments. For instance, the connection can retain the attachment of the foot treatment element to the movement-generating element under certain separating forces (e.g., gravity, etc.). Other forces, however (e.g., user pulling forces, etc.) can reversibly separate the foot treatment element from the movement-generating element.

The movement generating element can also comprise a connection element or component (e.g., for attaching the body to the movement-inhibiting element). For instance, the body can include one or more attachment members for reversibly connecting the movement generating element to the surface-stabilizing element(s) and/or surface immobilizing element(s).

In another embodiment, the body can comprise one or more side (towers) (e.g., extending vertically upward from the base element). The tower(s) can have one or more foot treatment elements (e.g., comprising an exfoliating element, massaging element, plurality of bristles, etc.) extending therefrom (e.g., from one or more surfaces). The tower(s) can also have a selective operation mechanism (e.g., on-off switch or push button). In another embodiment, the body can comprise a single and/or central tower having one or more foot treatment elements (e.g., extending from opposing sides (and, optionally, a front surface) thereof).

### Movement-Inhibiting Elements

The foot care device can include at least one movement-inhibiting element. The movement-inhibiting element(s) can comprise a base member connected (directly or indirectly) to the movement-generating element (or the body, base, or lower surface thereof). The at least one movement-inhibiting element can be configured to secure the movement-generating element to a surface (e.g., floor) and/or inhibit positional movement of the movement-generating element about the surface. For instance, the movement-inhibiting element can have or comprise a surface or positional immobilizing element and/or a surface-stabilizing element.

The surface or positional immobilizing element can comprise one or more suction or friction members extending from the bottom surface of the movement-inhibiting element. Alternatively, the suction or friction members can be connected to the lower surface of the movement-generating element (or the body or base thereof).

The surface stabilizing element can comprise one or more surface stabilizing members extending (radially and/or laterally outwardly) from movement-generating element (or the body or base thereof). For instance, stabilizing member can comprise one or more (foot) platforms configured to have a force applied thereto to promote stability or reduce movement of the device about the surface. In some embodiments, the force can comprise pressure applied by at least one foot of a user. In an alternative embodiment, the at least one surface stabilizing element can extend (directly or indirectly) from the body or base of the movement-generating element. The movement-inhibiting element or surface stabilizing element(s) thereof can also include one or more gripping elements (e.g., on the upper surface and/or lower surface thereof, or on the upper surface and/or lower surface of the platforms).

In some embodiments, the movement-inhibiting element or surface stabilizing element(s) thereof can also have one or more foot treatment elements attached or connected thereto or extending therefrom (e.g., to an upper surface thereof). For instance, the base can include at least one exfoliating element and/or one or more bristles, brushes, fibers, etc. (e.g., connected to and/or extending from the (upper) surface(s) thereof).

### Foot Treatment Elements

Embodiments of the present disclosure include one or more foot treatment elements. The foot treatment element can be connected to and/or extend from the movement-generating element or body, housing, wall, exterior surface, and/or receiving area thereof. The foot treatment element(s) can comprise an exfoliating element (e.g., natural or synthetic pumice), a massaging element (e.g., elastomeric protuberances) and/or cleaning (or brushing) element (e.g., bristles of one or more lengths, gauges, and/or densities), which can be attached to a surface of a vibrating body. Alternatively, the foot treatment element(s) can comprise a removable insert (e.g., plate member) reversibly attached to the surface of a vibrating body or receiving area thereof. The insert can be or have a shape or configuration corresponding to and/or suitable for attachment to the vibrating body or receiving area thereof. For instance, the insert can have a generally, substantially, and/or at least partially recessed or concave surface and/or configuration (e.g., a U-shaped, J-shaped, or L-shaped configuration).

As used herein, reference to “pumice” can include natural and/or synthetic pumice. Other exfoliating elements (e.g., particulate and/or crystalline-embedded material) and/or (dead) skin removal elements (e.g., razor(s), blade(s), grater(s), file(s), etc.) are also contemplated herein. Similarly, the massaging element or elastomeric protuberances can comprise silicone, rubber, or other material configured to provide a comfortable skin contact. The cleaning element can alternatively comprise a sponge, loofah, or other skin cleansing member.

One or more embodiments of the present disclosure comprise a kit that includes a plurality of interchangeable foot treatment elements. For instance, certain kits can include two or more (replaceable) inserts. The inserts, respectively, can include an exfoliating element, massaging element, and/or cleaning element. In certain embodiments, the kit can include at least one insert having an exfoliating element, at least one insert having a massaging element, and/or at least one insert having a cleaning or brushing element.

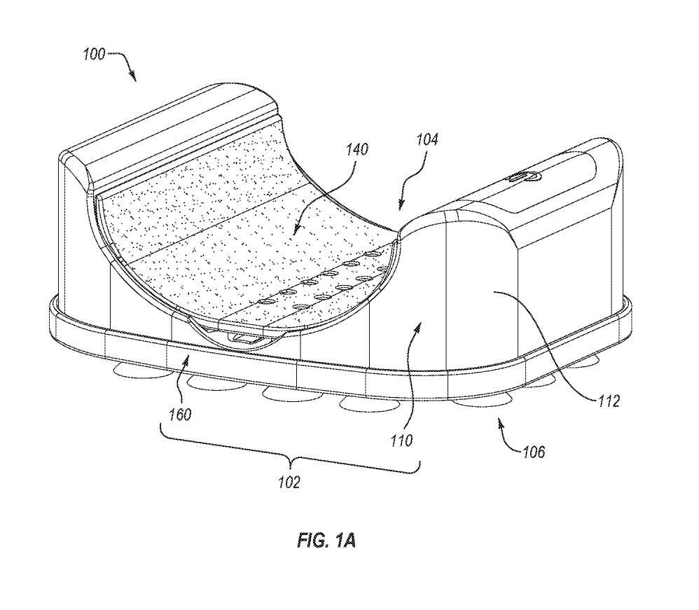

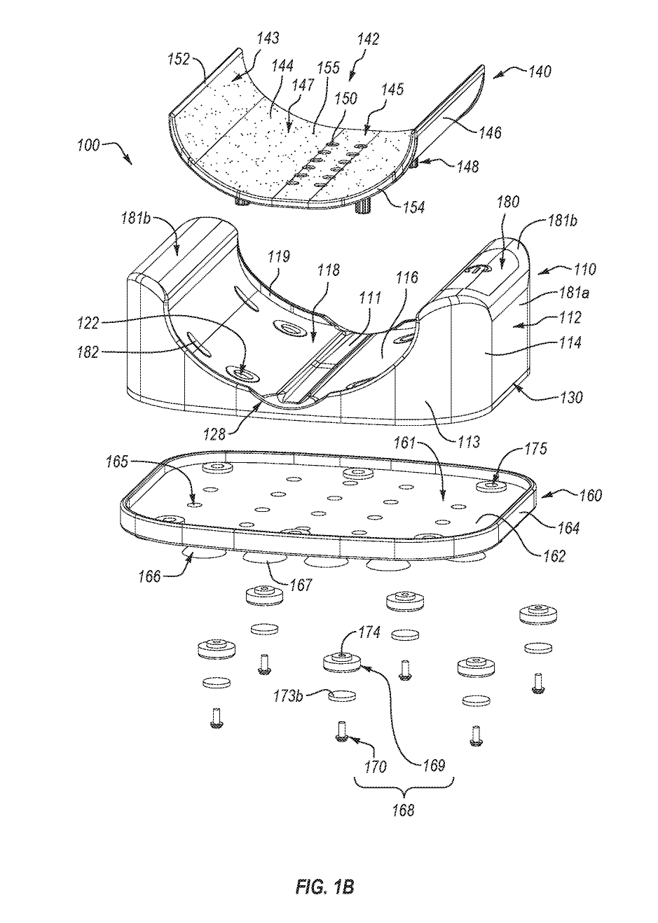

Referring now to the figures, one or more implementations of the present disclosure comprise a foot care device configured for treating feet (e.g., in the shower). For example, FIG. 1A illustrates a perspective view of an illustrative foot care device 100 according to one implementation of the present disclosure. Foot care device 100 has an upper treatment area 104 and a lower surface attachment area 106. Foot care device 100 comprises a treatment assembly 102 and a foot treatment element foot treatment element 140 connected to treatment assembly 102. Treatment assembly 102 includes an upper movement-generating element (or (vibrating) body) 110 (comprising a housing 112), and an immobilizing element 160 connected to a lower portion of movement-generating element 110. Foot treatment element 140 is connected to an upper portion of movement-generating element 110.

The various components of foot care device 100 will now be described in further detail. It will be appreciated that the various components of foot care device 100 can comprise and/or be formed of any suitable material(s), including without limitation, one or more metals or metal alloys, polymeric or plastic materials, and/or any other (naturally-occurring and/or synthetic) substance(s). For instance, in at least one embodiment, one or more components of foot care device 100 (e.g., immobilizing element 160 and/or component(s) thereof) can be comprised of one or more elastomeric, polymeric, rubberized, and/or other (flexible) materials (e.g., rubber, silicone, etc.). In certain embodiments, one or more components of foot care device 100 (e.g., movement-generating element (or body) 110 and/or component(s) thereof) can be comprised of one or more substantially, partially, and/or semi-rigid materials (e.g., polymeric, plastic, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), etc.). As discussed in further detail below, foot care device 100, or one or more components thereof, can also comprise a water-proof, water-tight, or water-resistant material and/or configuration in certain embodiments.

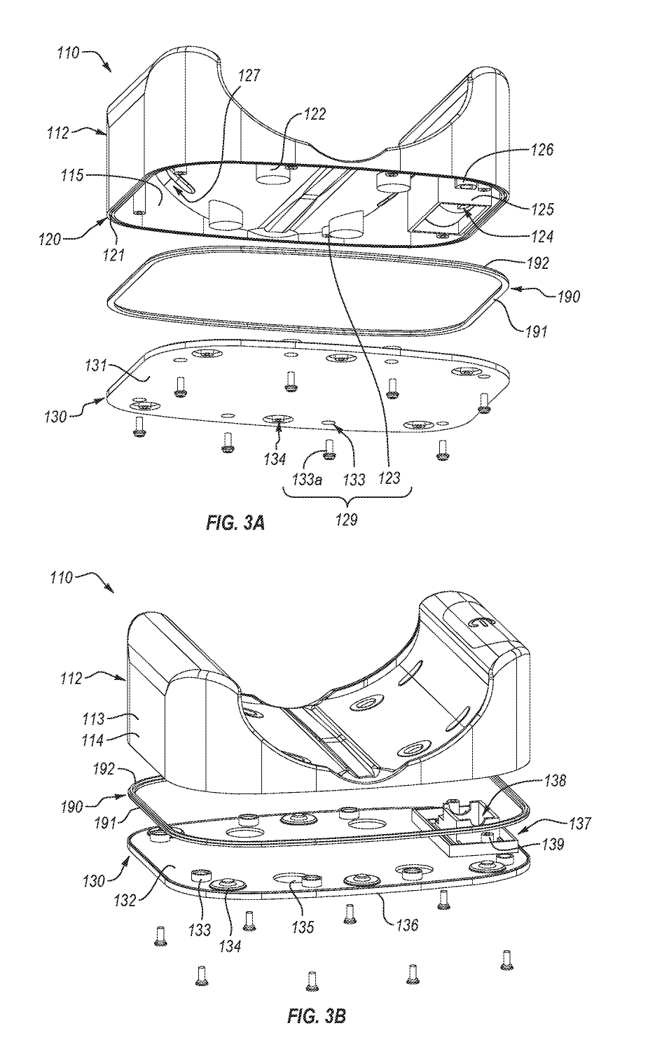

FIG. 1B illustrates an exploded view of foot care device 100. As depicted in FIG. 1B, movement-generating element 110 comprises an upper body portion (or housing) 112 and a lower base portion (or plate) 130 connected to body portion 112. Housing 112 comprises a wall 113 having an outer surface 114 and, as illustrated in FIG. 3A, inner surface 115. Housing 112 or wall 113 thereof also has or comprises opposing sides or side towers 181a, each having an upper portion 181b. With continued reference to FIG. 3A, wall 113 also includes lower edge 120 extending between outer surface 114 and inner surface 115 at a lower edge of wall 113 (or movement-generating element 110 or housing 112). Movement-generating element 110, or housing 112 thereof, or inner surface 115 thereof, partially bounds cavity 127. Lower edge 120 comprises and/or defines an opening of or into cavity 127.

Returning now to FIG. 1B, movement-generating element 110, or housing 112 thereof, or wall 113 thereof comprises upper surface 116 opposite lower edge 120. Upper surface 116 is disposed in a receiving area 118, configured for receiving foot treatment element 140. For instance, movement-generating element 110, or upper surface 116 thereof includes a plurality of receiving elements 122. As described in further detail below, each receiving element 122 comprises a (recessed) socket configured for receiving the post of connection component 148 of foot treatment element 140, to thereby reversibly secure foot treatment element 140 to treatment assembly 102, or movement-generating element 110 thereof, receiving elements 122 and connection component 148 comprising an attachment mechanism. Upper surface 116 also has a channel 111 extending from a first end (or front) thereof, to a second end (or back) thereof.

Movement-generating element 110 also includes retaining wall 119 extending upwardly from outer surface 114 and/or upper surface 116. At least a portion of retaining wall 119 can extend upwardly beyond at least a portion of upper surface 116, such that when foot treatment element 140 is attached to movement-generating element 110 or disposed in receiving area 118 thereof, as depicted in FIG. 1A, retaining wall 119 at least partially retains foot treatment element 140 in receiving area 118. In addition, movement-generating element 110 includes one or more buffering elements 182 (e.g., in receiving area 118 and/or attached to upper surface 116). Buffering elements 182 can be configured to reduce and/or inhibit (rattling) noises generated by (contact between) movement-generating element 110 and foot treatment element 140.

Movement-generating element 110 also includes a movement-generating mechanism. For instance, as illustrated in FIGS. 3A and 3B, movement-generating element 110 or the movement-generating mechanism thereof includes a movement-generating device 124. Movement-generating device 124 can be or comprise a vibration motor, an oscillating motor, a reciprocating motor, etc. Movement-generating element 110 or the movement-generating mechanism thereof can also include a power source connected to movement-generating device 124. For instance, movement-generating element 110 can have an electrical power source, such as one or more batteries (not shown), disposed within cavity 127 and/or electrically coupled with movement-generating device 124. The one or more batteries can be replaceable, rechargeable, alkaline, lithium ion, induction-charged, and/or other types of batteries.

Movement-generating element 110 or the movement-generating mechanism thereof can also include an operating mechanism (e.g., or other means for (selectively) operating and/or engaging movement-generating device 124). As depicted in FIG. 1B, for instance, movement-generating element 110 or the movement-generating mechanism thereof also includes an activation element 180 (e.g., disposed at upper portion 181b of side portion 181a of housing 112 or wall 113 thereof). As depicted, activation element 180 comprises a touch and/or push button configured to activate movement-generating device 124 (e.g., through one-touch activation). In alternative embodiments, however, activation element 180 or other means for (selectively) operating and/or engaging movement-generating device 124 can be or comprise an on switch, on-off switch, slidable (and/or variable) switch, dial, knob, or wheel, and/or any other suitable operating mechanism. In at least one embodiment, activation element 180 automatically disengages movement-generating device 124 after a predetermined period of time, such as, for example, about 15 seconds, 30 seconds, 45 seconds, 60 seconds, 75 seconds, or 90 seconds, or any amount of time or range of times therebetween.

Movement-generating device 124 can be physically and/or directly connected to housing 112, or a component thereof. For instance, housing 112 includes a compartment 125 disposed in cavity 127. Compartment 125 at least partially bounds and/or secures movement-generating device 124 (therein). Compartment 125 can also have one or more attachment elements 126 (extending therefrom). Attachment elements 126 can at least partially align and/or secure base 130 with housing 112. Base 130 can cover and/or substantially seal the opening formed and/or defined by lower edge 120. Base 130 has a lower surface 131 and an upper surface 132 opposite lower surface 131.

Upper surface 132 of base 130 can be mated with lower edge 120 of housing 112 and secured thereto by any suitable attachment mechanism. For instance, upper surface 132 can be secured to lower edge 120 by means of attachment mechanism 129. Attachment mechanism 129 includes a plurality of receiving elements 123 of housing 112 and/or extending from inner surface 115 thereof, a plurality of through-holes 133 extending through base 130 from lower surface 131 to upper surface 132, and a plurality of fasteners 133a. Fasteners 133a can extend through through-holes 133 and into receiving elements 123. Fasteners 133a can be secured to or within receiving elements 123 by any suitable mechanism. For instance, fasteners 133a can have a threaded outer portion corresponding to a threaded inner portion of receiving elements 123. A pressure fit, snap fit, twist fit, locking fit, or other suitable mechanism known in the art may be employed to secure fasteners 133a to or within receiving elements 123. Those skilled in the art will appreciate, however, that other suitable attachment mechanism 129 can be used (interchangeably) to secure upper surface 132 to lower edge 120.

In at least one embodiment, base 130 can seal the opening formed and/or defined by lower edge 120. For instance, movement-generating element 110 can also include sealing element 190. Sealing element 190 comprises a seal, gasket, or o-ring configured to create a water-proof, water-tight, or water-resistant connection or seal between housing 112 and base 130. Lower edge 120 also includes recess 121, configured to receive at least a portion of sealing element 190 therein. For instance, sealing element 190 can have sealing insert 192 sized and/or configured to be inserted and/or disposed within recess 121 of lower edge 120. Sealing element 190 can also have base portion 191 configured to sit or rest on upper surface 132 of base 130. As illustrated in FIG. 1B, a tight seal (e.g., devoid of any water penetrating gaps or cracks) can be formed between housing 112 and base 130 (by means or virtue of sealing element 190). In addition, base 130 can include outer edge 136, which, as further illustrated in FIG. 1B, can be aligned and/or (substantially) flush with wall 113, or outer surface 114 thereof.

With continued reference to FIGS. 3A and 3B, base 130 also has compartment 137 (e.g., extending from upper surface 132 thereof). Compartment 137 aligns with compartment 125 to substantially enclose movement-generating device 124 in a chamber formed by compartment 125 and compartment 137. For instance, compartment 137 includes socket 138 configured to receive at least a portion of movement-generating device 124 and/or compartment 125 therein. In at least one embodiment, at least a portion of socket 138 can be received at least partially within compartment 125. Compartment 137 can also include one or more attachment members 139. Attachment members 139 can be aligned with, received by, and/or inserted into attachment element 126 (e.g., so as to properly align and/or secure base 130 with housing 112). Alternatively, attachment element 126 can be aligned with, received by, and/or inserted into attachment member 139 (e.g., so as to properly align and/or secure base 130 with housing 112).

Base 130 also includes one or more receiving members 135 (e.g., recessed into upper surface 132). Receiving members 135 can be aligned with receiving elements 122 such that when base 130 is attached to housing 112, as illustrated in FIG. 1B, receiving elements 122 is at least partially inserted into and/or received by receiving members 135 (further properly aligning base 130 with housing 112). Base 130 also includes a plurality of attachment elements 134 (e.g., for connecting and/or attaching immobilizing element 160 thereto, as discussed in further detail below).

As indicated above, however, some embodiments need not include movement-generating device 124. Instead, certain embodiments include non-motorized and/or non-vibrating devices and/or kits. Specifically, certain implementations of the present disclosure can avoid the need for electricity consumption by including a manual or mechanical movement-generating element 110 or device thereof. For instance, an alternative movement-generating element 110 can comprise a wind-up, retracting pull-string, or other mechanical energy source configured to receive and store mechanical and/or potential energy for selective operation of movement-generating element 110. In addition, certain embodiments need not include a movement-generating mechanism (or device 124, batteries, etc.). In such embodiments, device 100 may comprise a stationary body as body 110 (e.g., instead of a movement-generating element 110).

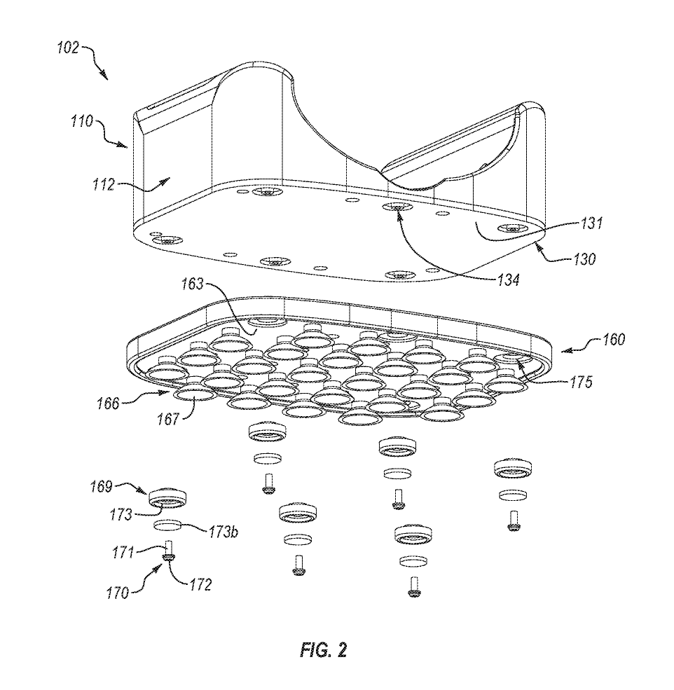

Returning now to FIG. 1B, and with reference to FIG. 2, immobilizing element 160 has an upper surface 162 and a lower surface 163 opposite upper surface 162. Immobilizing element 160 also includes a side wall 164 extending upwardly from and/or beyond upper surface 162. Side wall 164 and upper surface 162 at least partially bound a receiving area (or recess, socket, cavity, etc.) 161 (configured for receiving movement-generating element 110 therein). Immobilizing element 160 also includes a plurality of through-holes 165 and a plurality of attachment openings 175 extending therethrough and/or from upper surface 162 to lower surface 163. Through-holes 165 can allow and/or insure that any water or other fluid or material disposed in receiving area 161 can drain out thereof. Attachment openings 175 provide a means for securing immobilizing element 160 to movement-generating element 110 and/or base 130 thereof. Immobilizing element 160 can be (reversibly) connecting and/or attached to movement-generating element 110 (or base 130 thereof) by means of attachment mechanism 168 (as illustrated in FIG. 1A).

Attachment mechanism 168 includes a plurality of footings 169 and a plurality of corresponding fasteners 170. Fasteners 170 can be inserted through opening 174 of footings 169, through attachment opening 175 of immobilizing element 160, and into attachment element 134 of base 130. Fasteners 170 can comprise a head 172 and a shaft 171 connected thereto and/or extending therefrom. Footing 169 comprises a recess (socket) 173 for receiving head 172 upon insertion of shaft 171 through opening 174. In addition, a capping element 173b can be secured to footing 169 so as to cover recess 173 and/or conceal fastener 170 (or head 172 thereof). Fasteners 170 and/or shaft 171 thereof can be secured to or within attachment elements 134 (or opening 174 and/or recess 173 thereof) by any suitable mechanism. For instance, shaft 171 can have a threaded outer portion corresponding to a threaded inner portion of attachment elements 134. A pressure fit, snap fit, twist fit, locking fit, or other suitable mechanism known in the art may be employed to secure at least a portion of shaft 171 to or within attachment elements 134. Those skilled in the art will appreciate, however, that other suitable attachment mechanism 168 can be used (interchangeably) to secure immobilizing element 160 to movement-generating element 110 or base 130 thereof.

Immobilizing element 160 also includes a movement-inhibiting element 166. Movement-inhibiting element 166 can be configured to attach and/or secure foot care device 100, treatment assembly 102 thereof, and/or immobilizing element 160 thereof to a support or attachment surface. Accordingly, movement-inhibiting element 166 can be disposed on, connected to, and/or extend from lower surface 163 of immobilizing element 160. As depicted herein, movement-inhibiting element 166 comprises a plurality of suction elements (or cups) 167 (e.g., extending from and/or disposed about lower surface 163 of immobilizing element 160). As understood by those skilled in the art, suction elements 167 can create negative pressure and/or (releasable) vacuum sufficient to (reversibly) attach and/or secure immobilizing element 160 to a variety of surface types. In particular, movement-inhibiting element 166 and/or suction elements 167 thereof can attach and/or secure immobilizing element 160 to tile, ceramic, marble, stone, wood, vinyl, linoleum, or other type of flooring or structural surface. In addition, movement-inhibiting element 166 and/or suction elements 167 thereof can attach and/or secure immobilizing element 160 to porcelain, fiberglass, or other type of shower, bathtub, spa, hot tub, swimming pool, or other structural surface.

FIG. 1B also illustrates foot treatment element 140. Foot treatment element 140 comprises an insert having an upper surface 144 and a lower surface 146 opposite upper surface 144. Upper surface 144 forms and/or defines a treatment area 142. Upper surface 144 and/or treatment area 142 thereof can have or comprise a recessed or concave configuration (e.g., substantially similar and/or corresponding to the concave configuration of receiving area 118. Indeed, as depicted herein, upper surface 144 and/or treatment area 142 thereof has a substantially U-shaped configuration. Foot treatment element 140 also includes connection component 148 disposed on and/or extending from lower surface 146, and an exfoliating element 155 disposed on and/or connected to upper surface 144. In the depicted embodiment, exfoliating element 155 comprises a synthetic pumice material disposed over (the entire) upper surface 144. In particular, upper surface 144 comprises opposing side portions 143 extending from opposite sides of bottom portion 145, and intermediate (sloping) portions 147 disposed between side portions 143 and bottom portion 145. Exfoliating element 155 extends from bottom portion 145, over intermediate portions 147, and up both side portions 143 to top edge 152. Those skilled in the art will appreciate, however, that exfoliating element 155 need not extend over the entire upper surface 144.

In the depicted embodiment, connection component 148 comprises a plurality of posts extending from lower surface 146. Foot treatment element 140 can be received in receiving area 118 by inserting the posts of connection component 148, respectively, into receiving elements 122. As a result, lower surface 146 is disposed against upper surface 116 as depicted in FIG. 1A (e.g., with buffering elements 182 disposed therebetween to reduce and/or inhibit rattling noises caused during operation of the movement generating mechanism). Similarly, side edge 154 of foot treatment element 140 can fit snugly against retaining wall 119. In at least one embodiment, the fit and/or contact between side edge 154 and retaining wall 119 can provide a force (e.g., friction, pressure, etc.) that at least partially retains foot treatment element 140 within receiving area 118. In addition, as indicated above, connection component 148 can cooperate with receiving elements 122 to at least partially retain foot treatment element 140 within receiving area 118. For instance, connection component 148 and receiving elements 122 can form a partial locking fit. Alternatively, a pressure fit, snap fit, or other suitable mechanism known in the art may be employed to secure connection component 148 to or within receiving elements 122.

Those skilled in the art will appreciate that the socket and post configuration of the attachment mechanism comprised of receiving elements 122 and connection component 148 can produce a substantially secured, reversibly attachable connection between foot treatment element 140 and movement-generating element 110. For instance, the connection can retain the attachment of foot treatment element 140 to movement-generating element 110 under certain (mild) separating forces (e.g., gravity, etc.). Other forces, however (e.g., user pulling forces, etc.) can reversibly separate foot treatment element 140 from movement-generating element 110.

Foot treatment element 140 and/or bottom portion 145 thereof also has a plurality of drain holes 150 extending therethrough. By connecting connection component 148 to receiving elements 122 (e.g., by insertion), drain holes 150 can become substantially aligned with channel 111, such that water or other fluid (and/or components disposed and/or suspended therein) can be drained through drain holes 150 and off of upper surface 116 (and/or out of receiving area 118) by means of channel 111. Thus, standing water or other fluid may be channeled away from receiving area 118 so as to attenuate and/or substantially prevent mildew, mold, or other undesirable drawbacks of fluid.

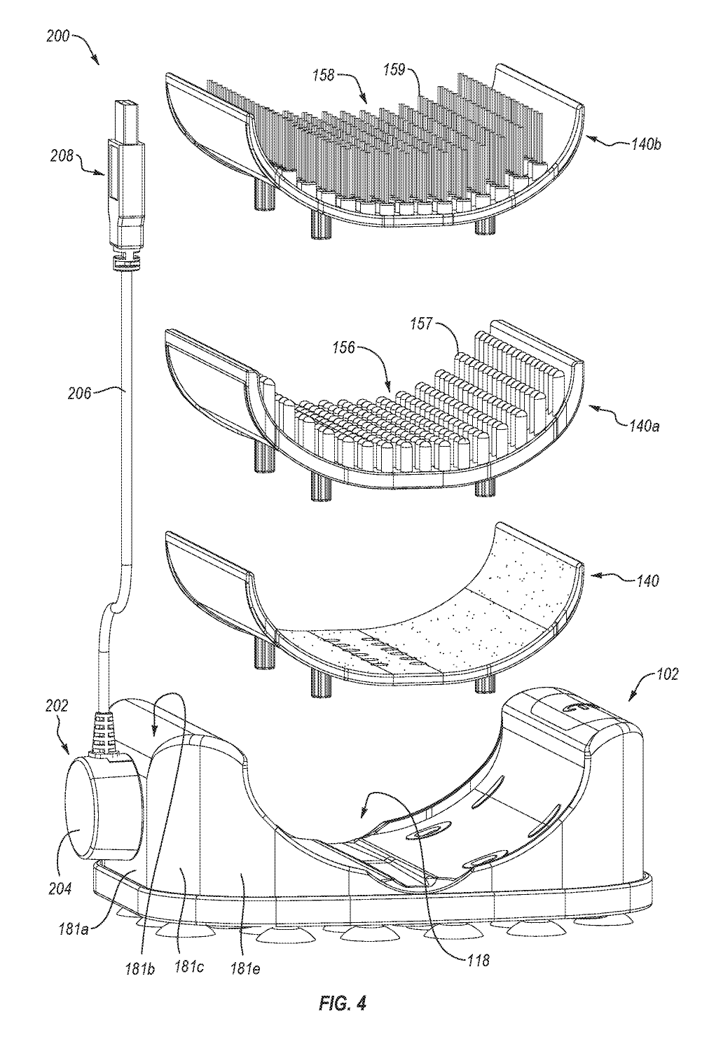

FIG. 4 illustrates foot care kit 200 comprising treatment assembly 102 and a plurality of interchangeable foot treatment element 140. For instance, foot care kit 200 includes a first foot treatment element 140, as described above, a second foot treatment element 140a, and a third foot treatment element 140b. Unlike foot treatment element 140, foot treatment element 140a comprises a massaging element 156 disposed on and/or connected to upper surface 144 thereof. In the depicted embodiment, massaging element 156 comprises a plurality of massaging members 157. Massaging member 157 can comprise a flexible and/or elastomeric protuberance (formed of silicone or other flexible and/or polymeric material). Those skilled in the art will appreciate, however, that massaging members 157 can be comprised of any suitable material(s) and that massaging element 156 can comprise any (number of) suitable massaging member or components thereof. Similarly, in the depicted embodiment, foot treatment element 140b comprises a cleansing element 158 comprises a plurality of bristles 159. Bristles 159 can be any suitable length, gauge, and/or density, or combination thereof. In at least one alternative embodiment can comprise a foot treatment element having two or more types of foot treatment members disposed thereon.

Kit 200 also includes an optional charging component 202. Charging component 202 includes an induction component 204, a cord 206 extending from induction component 204, and a plug 208 connected to the opposing end of cord 206. Plug 208 can be configured as a UBD plug, (110V) outlet plug, or any other suitable configuration or arrangement as applicable in various countries and/or regions. As indicated above, treatment assembly 102 can include one or more batteries disposed within cavity 127 of housing 112 (referencing FIG. 3A). Moreover, cavity 127 can be water-tight, water-proof, and/or water-resistant. For instance, cavity 127 can be sealed with the one or more batteries protected inside from water or other fluid damage. Accordingly, to ensure and/or facilitate extended and/or repeated use of the foot care device, the one or more batteries can comprise at least one inductively charged battery.

As depicted, induction component 204 can be (magnetically) connected to the side surface of side tower 181a (e.g., on the opposite side of treatment assembly 102 that activation element 180 is disposed on). It will be appreciated, however, that induction component 204 can be attached to the (respective surface of) upper portion 181b, corner 181c, or face 181e in certain embodiments (e.g., depending on the location of the one or more batteries within treatment assembly 102. Some embodiments need not include batteries. For instance, as indicated above, certain embodiments may be or include non-electric, non-motorized, and/or non-vibrating devices and/or kits.

In an alternative embodiment, however, the one or more batteries can be disposed within a battery compartment having a covered access opening. For instance, FIG. 5 illustrates treatment assembly 102a comprising movement-generating element 110a and immobilizing element 160a. Movement-generating element 110a comprises housing 112a substantially similar in configuration and features to housing 112. However, housing 112a includes a covering 184 for accessing a battery compartment 109 disposed inside cavity 127a thereof. Accordingly, in the depicted embodiment, the one or more batteries may comprise removable and/or replaceable batteries. It will be appreciated that covering 184 can substantially seal the one or more batteries inside battery compartment 109 such that the one or more batteries are protected inside from water or other fluid damage.

Movement-generating element 110a also utilizes an attachment mechanism 129a (e.g., that is different than attachment mechanism 129 of movement-generating element 110). Specifically, rather than a plurality of fasteners 133a, movement-generating element 110a and/or attachment mechanism 129a thereof comprises a plurality of fasteners 133b, each of which extend into or through receiving opening 133 of base 130a. As depicted in FIG. 5, each fastener 133b comprises a (two-piece, outwardly biasing and/or expanding) clip configured to be inserted into receiving opening 133 to secure and/or retain base 130a to housing 112a. Accordingly, to separate base 130a from housing 112a, fastener 133b is disengaged and/or removed from receiving opening 133 (e.g., by squeezing the two halves of fastener 133b together).

Similarly, treatment assembly 102a utilizes a different attachment mechanism 168a. Specifically, rather than a plurality of fasteners 170 extending through openings 174, respectively, of footings 169, through attachment openings 175 of immobilizing element 160, and into attachment elements 134 of base 130 (as in treatment assembly 102), attachment mechanism 168a of treatment assembly 102 utilizes and/or includes a plurality of fasteners 170a extending from the lower surface 131a of base 130a, through attachment opening 175a of immobilizing element 160a, and into a receiving opening or socket 173a in footing 169a, respectively. Fasteners 170a can be configured similar to fasteners 133b. In addition, immobilizing element 160a includes side wall 164a that does not extend beyond the upper surface thereof. Accordingly, immobilizing element 160a does not include a recessed receiving area 161 as does immobilizing element 160. Instead, side wall 164a can be aligned and/or substantially flush with outer edge 136a of base 130a and/or the exterior surface 114a of housing 112a (or wall 113a thereof) when treatment assembly 102a is assembled together.

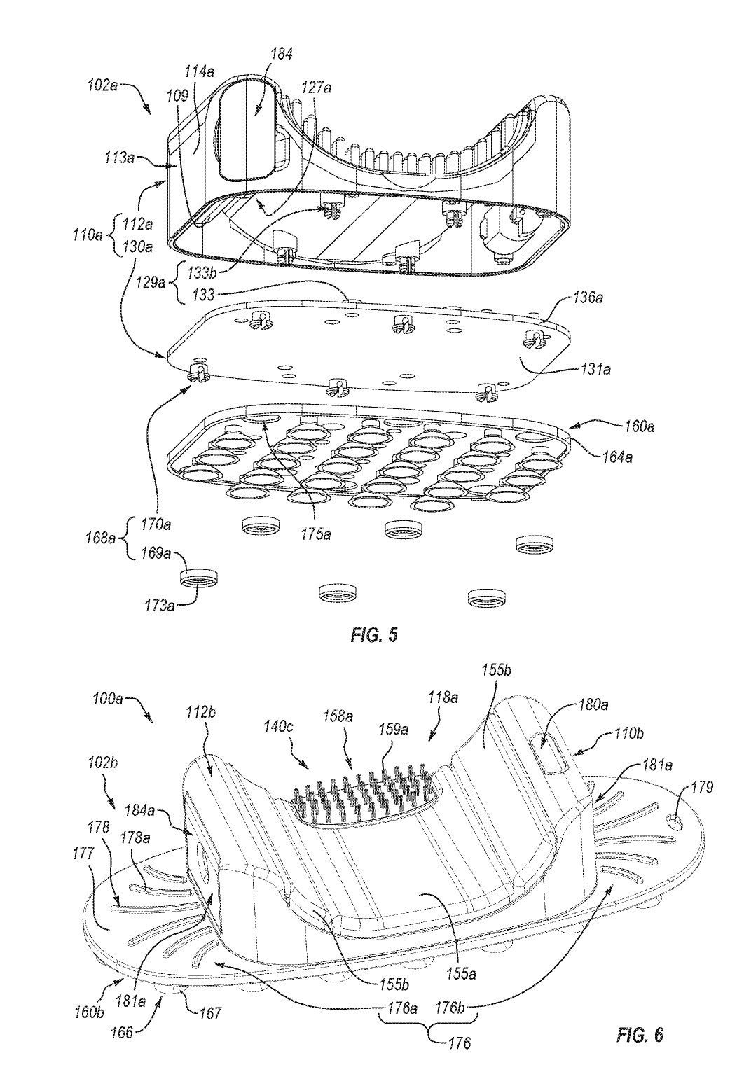

FIG. 6 illustrates another embodiment having one or more additional or alternative features. As depicted in FIG. 6, foot care device 100a comprises a treatment assembly 102b, including movement-generating element or body 110b having a housing 112b, an immobilizing element 160b connected to the bottom portion of movement-generating element 110b or housing 112b thereof, and a foot treatment element 140c connected to the top portion of movement-generating element 110b and/or disposed in receiving area 118a of housing 112b. Movement-generating element 110b, housing 112b, and/or receiving area 118a thereof has a U-shaped configuration similar to other embodiments disclosed herein. However, housing 112b has a covering 184a on the surface of side tower 181a for accessing a battery compartment disposed inside the cavity thereof. Similar to covering 184, covering 184a can substantially seal one or more batteries inside the battery compartment such that the one or more batteries are protected inside from water or other fluid damage.

Foot care device 100a and/or movement-generating element 110b thereof also includes activation element 180a. The push button of activation element 180a can be substantially similar to and/or smaller in size than the push button of activation element 180. It will also be appreciated that foot care device 100a need not include batteries and/or may not be motorized and/or selectively vibrational in some embodiments.

As depicted, foot treatment element 140c has a first exfoliating element 155a and opposing exfoliating elements 155b on either side of exfoliating element 155a. Foot treatment element 140c also includes a cleansing element 158a comprising a plurality of bristles 159a. In an alternative embodiment, cleansing element 158a can be disposed on either side of exfoliating element 155a (e.g., instead of exfoliating elements 155b). In such an embodiment, bristles 159a my comprise bristles of a longer and/or softer length, gauge, and/or density. Accordingly, foot treatment element 140c can include a variety of different types of foot treatment members. In at least one embodiment, foot treatment element 140c and/or one or more component(s) thereof can be attached to movement-generating element 110b and/or receiving area 118a so as to be substantially irremovable. For instance, foot treatment element 140c and/or one or more component(s) thereof can be attached to movement-generating element 110b and/or receiving area 118a by means of an adhesive or other attachment mechanism configured to retain foot treatment element 140c and/or one or more component(s) thereof on the surface of movement-generating element 110b and/or receiving area 118a. However, foot treatment element 140c and/or one or more component(s) thereof can also be removably attached.

Immobilizing element 160b can be configured similar to immobilizing element 160 and/or immobilizing element 160a in certain embodiments. For instance, immobilizing element 160b also includes movement-inhibiting element 166 comprising a plurality of suction elements (or cups) 167 disposed on the lower surface of immobilizing element 160b. Immobilizing element 160b also includes an upper surface 177. An opening and/or recess in upper surface 177 receive movement-generating element 110b therein. Unlike immobilizing element 160 and/or immobilizing element 160a, however, immobilizing element 160b includes a surface stabilizing element 176 comprising a first stabilizing member 176a adjacent a first side portion 181a and/or a second stabilizing member 176b adjacent a second side portion 181a.

In at least one embodiment, stabilizing element 176, stabilizing member 176a, stabilizing member 176b, and/or component(s) thereof can be configured to provide a (gripping) feature on which a non-treatment foot can apply pressure to inhibit and/or substantially prevent positional movement of foot care device 100a about an attachment surface. For instance, immobilizing element 160b and/or upper surface 177 thereof includes one or more gripping elements 178. As depicted, gripping element 178 comprises a plurality of raised ridges 178a (e.g., extending upwardly therefrom). Gripping element 178 and/or raised ridges 178a thereof can provide a non-treatment foot gripping and/or massaging surface. It will be appreciated, however, that gripping element 178 and/or raised ridges 178a thereof can have or comprise a number of suitable configurations. It will also be appreciated that stabilizing element 176 and/or component(s) thereof can enhance the stability and/or reduce positional movement of foot care device 100a without necessarily having foot pressure applied thereto. For instance, stabilizing element 176 can also include a plurality of suction elements (or cups) 167 disposed on the lower surface thereof. In certain embodiments, immobilizing element 160b also includes a suspension element 179. As depicted, suspension element 179 can comprise an opening or through-hole in immobilizing element 160b. In at least one embodiment, foot care device 100a and/or immobilizing element 160b thereof can be suspended (e.g., hung) from a hook or other device by means of suspension element 179.

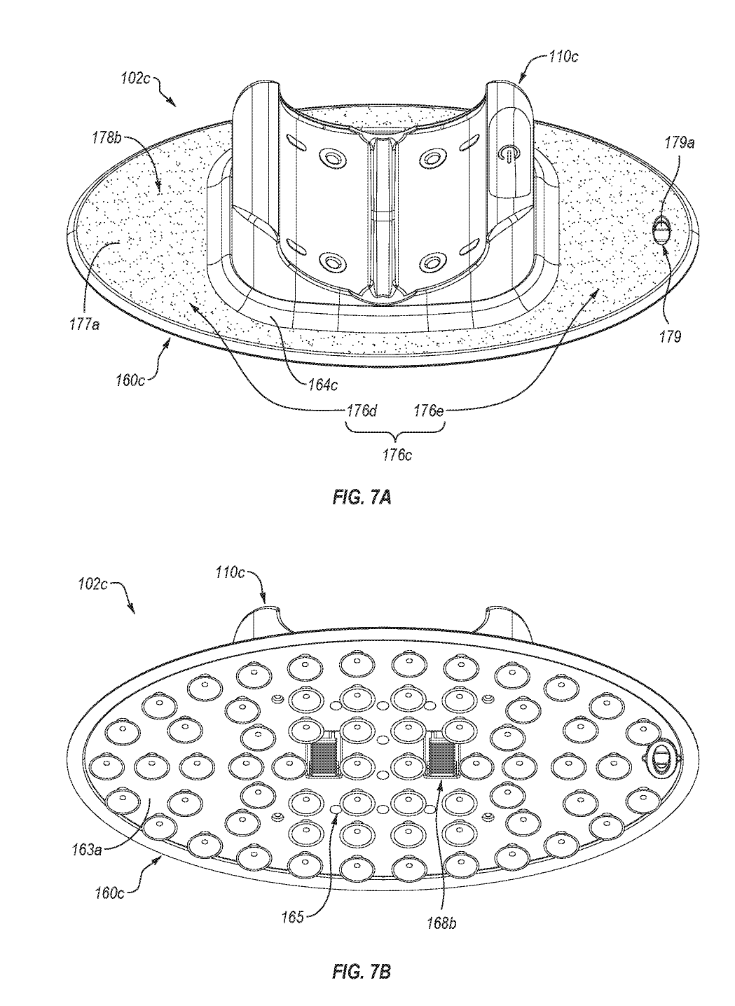

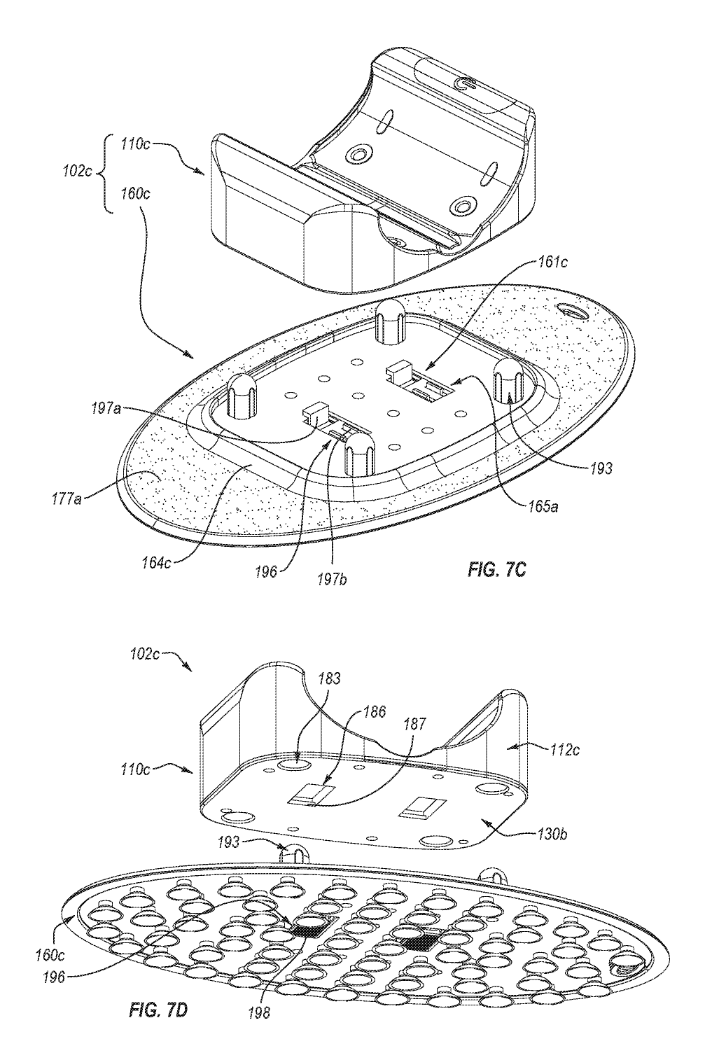

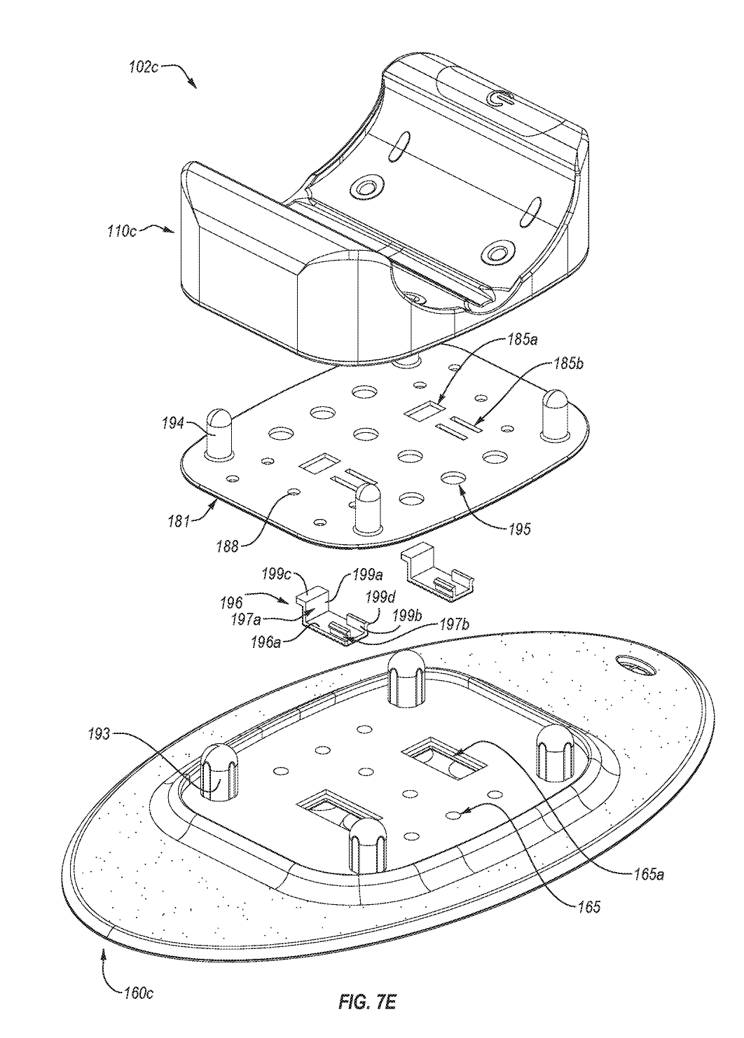

FIGS. 7A-7E illustrate another embodiment that comprises treatment assembly 102c. It will be appreciated that treatment assembly 102c can be included in a foot care device 100 or foot care kit 200 as described above. As illustrated in FIG. 7A, treatment assembly 102c includes a (substantially oval-shaped) immobilizing element 160c comprising stabilizing element 176c having a first stabilizing member 176d and an opposing second stabilizing member 176e. Immobilizing element 160c also has an upper surface 177a, an opposing lower surface 163a (as depicted in FIG. 7B), and a (movement-generating element 110c) receiving area 161a (as depicted in FIG. 7C). Upper surface 177a comprises a gripping element 178b (e.g., extending across or about at least a portion thereof). Gripping element 178b comprises a texturing (e.g., providing grip and/or traction for a non-treatment foot placed thereon). In addition, in certain embodiments gripping element 178b can comprise an exfoliating member, such as natural or synthetic pumice.

In some embodiments, immobilizing element 160c can comprise and/or be formed of one or more elastomeric, polymeric, rubberized, silicone, or other (flexible) materials. Accordingly, the texturing can comprise a textured surface of the material in certain embodiments. In other embodiments, immobilizing element 160c can comprise and/or be formed of one or more substantially, partially, and semi-rigid materials. Suspension element 179 of immobilizing element 160c includes a reinforcing member 179a (e.g., disposed therein and/or connected (adjacent) thereto). Immobilizing element 160c also includes side wall 164c forming a recess in which movement-generating element 110c is disposed.

As further depicted in FIG. 7B, immobilizing element 160c also includes a plurality of through-holes 165 extending therethrough. Treatment assembly 102c also includes attachment mechanism 168b attaching and/or connecting immobilizing element 160c to movement-generating element 110c and/or vice versa. As further depicted in FIGS. 7C-7E, attachment mechanism 168b can include one or more (e.g., a plurality of) attachment member 196 (e.g., disposed at least partially on or in and/or extending from or at least partially through immobilizing element 160c and/or receiving openings 165a thereof) and/or one or more (e.g., a plurality of) receiving element 186 (e.g., disposed on or in and/or extending through base 130b of movement-generating element 110c). At least a portion of attachment member 196 can be secured to and/or retained in receiving element 186 in an assembled configuration.

As depicted in FIG. 7E, attachment member 196 includes a body portion 196a, with a securing member 197a and opposing connection members 197b extending from an upper surface of body portion 196a. Specifically securing member 197a includes a vertical wall 199a and a horizontal lip or flange 199c. Similarly, each connection members 197b includes a vertical wall 199b and a horizontal lip or hook 199d. As depicted in FIGS. 7C-7D, securing member 197a is configured to be inserted into receiving element 186 and adjusted such that flip or flange 199c clips onto (or above) ledge 187 so that ledge 187 retains lip or flange 199c. For instance, attachment member 196 can be adjustably and/or moveably secured within receiving openings 165a. In particular, attachment member 196 can be advanced forward (i.e., in the direction of securing member 197a) and/or into a securing position. Likewise, attachment member 196 can be retracted backward (i.e., in the direction of connection members 197b) and/or into a releasing position. Accordingly, in at least one embodiment, the assembled treatment assembly 102c can be at least partially disassembled by retracting attachment member 196 (e.g., away from ledge 187) such that lip or flange 199c is no longer retained by ledge 187.

In some embodiments, attachment member 196 can be configured to resist advancing forward and/or retracting backwards as described above. For instance, attachment member 196 can be configured to at least partially lock into one or more (of the above-described) positions. Attachment member 196 can have a tight, friction, pressure, or other fit within receiving openings 165a. In an alternative embodiment, a biasing element (not shown) can bias attachment member 196 into the forward position. Accordingly, a retracting force capable of overcoming the biasing force of the biasing member may need to be employed in order to retract attachment member 196 into the releasing position. In one or more embodiments, body portion 196a also includes a lower surface having a gripping element 198 disposed thereon. Gripping element 198 can provide traction for a user to retract and/or advance attachment member 196 into the aforementioned or other positions.

Attachment mechanism 168b can also include one or more (e.g., a plurality of) alignment element 193 (e.g., extending upwardly from immobilizing element 160c and/or upper surface 177a thereof) and/or one or more (e.g., a plurality of) corresponding alignment component 183 (e.g., disposed on or in and/or extending through base 130b). Alignment element 193 is configured to be inserted into alignment component 183, thereby aligning movement-generating element 110c with immobilizing element 160c and/or retaining, attaching, and/or connecting immobilizing element 160c to movement-generating element 110c and/or vice versa. It will be appreciated, however, that because immobilizing element 160c can be formed of silicone or other flexible material(s), one or more additional components or materials may be required to provide alignment element 193 with the structural configuration, form, and/or rigidity to ensure suitable or proper alignment, attachment, and/or connection between immobilizing element 160c to movement-generating element 110c (or base 130b thereof), or vice versa. Accordingly, as illustrated in FIG. 7E, treatment assembly 102c can also include a frame element 181.

Frame element 181 comprises a substantially, partially, and/or semi-rigid material. For instance, frame element 181 can comprise and/or be formed of PVC or other polymeric and/or plastic material(s). Frame element 181 includes a plurality of through-holes 195 extending therethrough, and one or more additional perforations 188. Through-holes 195 can be configured to drain fluid through through-holes 165 and perforations 188 can provide some flexibility to frame element 181 or can reduce the weight thereof in certain embodiments. Frame element 181 also includes one or more connection opening 185a, one or more securing opening 185b, and/or one or more alignment members 194.

In at least one embodiment, frame element 181 can be formed into immobilizing element 160c (e.g., disposed and/or secured between upper surface 177a and lower surface 163a and/or the (interstitial) space disposed therebetween). For instance, in certain embodiments, immobilizing element 160c can be formed of an upper piece and a lower piece that have been (thermo-) formed together, such as by heating (e.g., thermoforming), welding, and/or adhering (e.g., with one or more suitable adhesives). During such forming, frame element 181 can be placed between the upper and lower pieces, alignment member 194 can be inserted into (tubular and/or substantially hollow) alignment element 193, connection opening 185a and securing opening 185b can be aligned with receiving openings 165a, and through-holes 195 can be aligned with through-holes 165. The upper and lower pieces can then be coupled, secured, and/or formed together with frame element 181 secured therebetween.

Attachment member 196 can then be attached to frame element 181 by inserting securing member 197a through connection opening 185a and inserting connection members 197b through securing openings 185b (e.g., through the bottom of receiving openings 165a on lower surface 163a. Lip or hook 199d can become clipped or otherwise retained by a portion of frame element 181 adjacent securing opening 185b, as illustrated in FIG. 7C. In an alternative embodiment, attachment member 196 can be clipped into frame element 181 prior to being formed and/or secured into immobilizing element 160c (e.g., between the upper and lower pieces thereof). In another embodiment, frame element 181 can be secured to the surface (e.g., upper surface 177a) of immobilizing element 160c, with frame element 181 comprising the equivalent of alignment element 193 and alignment member 194. In operation, wall 199c can contact the forward edge of connection opening 185a when attachment member 196 is in the forward securing position and/or the rear edge of connection opening 185a when attachment member 196 is in the retracted releasing position.

As depicted in FIG. 7D, alignment element 193 (e.g., with alignment member 194 disposed therein) can be inserted into alignment component 183 such that movement-generating element 110c becomes properly aligned with immobilizing element 160c. In addition, alignment element 193 can have a tight, friction, pressure, or other fit with alignment component 183. Accordingly, the connection between alignment element 193 and alignment component 183 can at least partially resist separation (below a certain threshold of separating force). For instance, when placed up-side-down (e.g., such that gravity pulls movement-generating element 110c (downwardly) away from immobilizing element 160c) the connection between alignment element 193 and alignment component 183 can at least partially resist separation (e.g., under the force of gravity—approximately 9.8 m/sec²×mass of movement-generating element 110c). However, in certain embodiments, a pulling and separating force substantially greater than the force of gravity (e.g., on movement-generating element 110c—for instance, greater than 1, 2, 3, 4, 5, 6, 7, 8, 9, 10, 12, 15, 20, 25, or 30 Newtons) can separate movement-generating element 110c from the upper surface of immobilizing element 160c (or receiving area 161a), or vice versa. For instance, a typical adult user can easily overcome the connection between alignment element 193 and alignment component 183 by pulling movement-generating element 110c and immobilizing element 160c apart.

Securing member 197a can also be inserted into receiving element 186 such that lip or flange 199c becomes retained and/or secured by ledge 187. The connection between lip or flange 199c and ledge 187 may resist separation of movement-generating element 110c from immobilizing element 160c, or vice versa (e.g., even under a separating force substantially greater than the force of gravity). However, by retracting attachment member 196 away from ledge 187 (e.g., by means of applying a force to gripping element 198 in a direction away from and/or substantially opposite to lip or flange 199c and/or ledge 187), lip or flange 199c can be disengaged from ledge 187 such that securing member 197a can be removed from receiving element 186 by a separating force. In combination with the connection between alignment element 193 (e.g., with alignment member 194 disposed therein) and alignment component 183, the separating force may need to be substantially greater than the force of gravity, for the reasons described above.

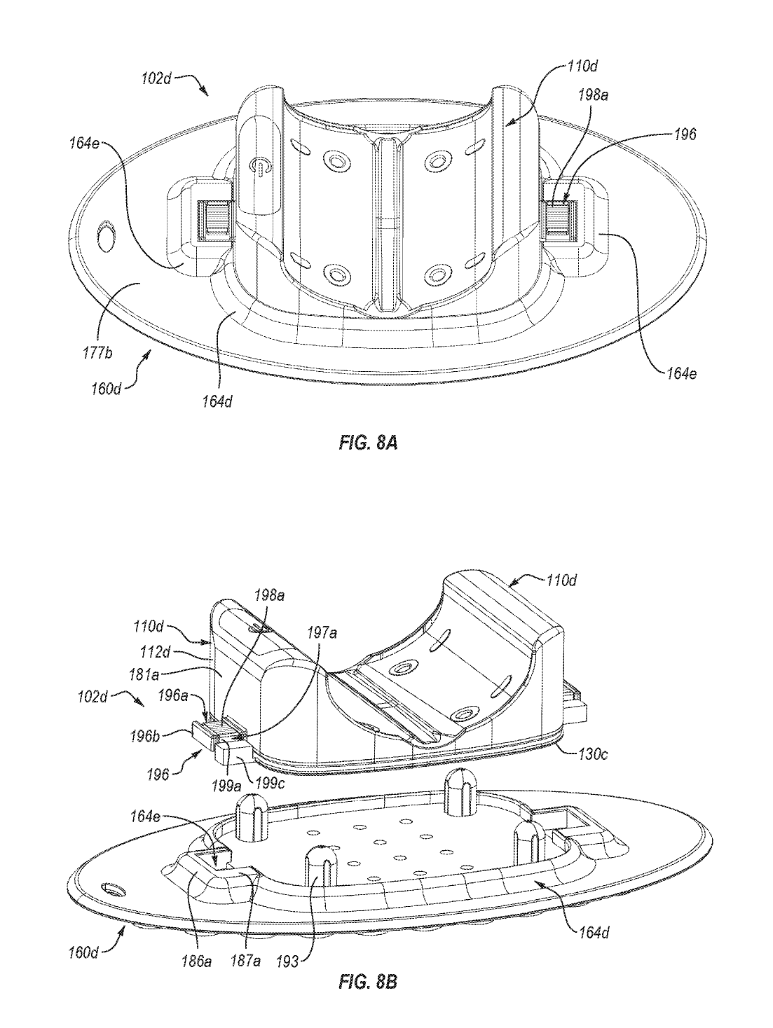

FIGS. 8A-8B depicts another embodiment comprising treatment assembly 102d, including movement-generating element 110d attached to immobilizing element 160d. As illustrated in FIG. 8A, immobilizing element 160d includes side wall 164d having opposing wall sockets 164e for receiving and/or accommodating attachment members 196. It will be appreciated that attachment member 196 of treatment assembly 102d can function substantially similar to attachment member 196 of treatment assembly 102c and/or have benefit(s) similar thereto. For instance, as further depicted in FIG. 8B, wall sockets 164e can have a receiving element 186a and ledge 187a (disposed therein). Attachment member 196 can also include a body portion 196a, with a securing member 197a extending therefrom. Securing member 197a comprises vertical wall 199a extending from body portion 196a, and lip or flange 199c extending from vertical wall 199a. Lip or flange 199c is structurally adapted to be inserted beneath ledge 187a upon assembly of treatment assembly 102d, to thereby resist separation of movement-generating element 110d from immobilizing element 160d, or vice versa.

In some embodiments, movement-generating element 110d can be separated from immobilizing element 160d by retracting body portion 196a (e.g., by means of applying a force to gripping element 198a in a direction away from and/or substantially opposite to lip or flange 199c and/or ledge 187a) thereby disengaging lip or flange 199c from ledge 187a such that attachment member 196 can be removed from receiving element 186a by a separating force. In combination with the connection between alignment element 193 (e.g., with alignment member 194 disposed therein) and alignment component 183, as described above, the separating force may need to be substantially greater than the force of gravity, for the reasons described above. It will also be appreciated that, unlike treatment assembly 102c, body portion 196a (and/or gripping element 198a thereof) can be disposed at and/or accessible from upper surface 177b of immobilizing element 160d.

In addition, attachment member 196 may be a component of and/or extend from movement-generating element 110d, or housing 112d thereof, or the surface of side tower 181a thereof. As depicted in FIG. 8B, for instance, attachment member 196 also includes a casing 196b connected to housing 112d. Body portion 196a can be moveably disposed and/or secured in casing 196b. Accordingly, body portion 196a can be moved and/or movable (within casing 196b) between a forward securing position, wherein lip or flange 199c is disposed substantially beneath ledge 187c, and a retracted releasing position, in which lip or flange 199c is drawn away from ledge 187c. In some embodiments, a biasing element (not shown) can be disposed between casing 196b and body portion 196a, such that body portion 196a is biased in the direction of lip or flange 199c and/or ledge 187a. The biasing element can include one or more springs or elastomeric components in some embodiments. In other embodiments, body portion 196a can have a tight, friction, pressure, or other fit within casing 196b. Accordingly, body portion 196a can be retained in the forward and/or retracted position by any suitable means or mechanism, which may be overcome by applying a suitable force thereto. It will also be appreciated that immobilizing element 160d can also have a frame element (not shown) disposed therein. In such an embodiment, receiving element 186a and/or ledge 187a may be components of the frame element (instead of base 130c).

One or more implementations can also include a method of using a foot treatment device of the present disclosure. The method can include providing a foot treatment device as disclosed herein. The method can include, placing the foot treatment device and on a floor or other support surface and applying an initial (securing and/or adhering) force to a portion of the foot treatment device (e.g., an immobilizing element or portion(s) thereof). The initial force can comprise downward pressure configured to secure the movement-inhibiting elements of the immobilizing element to the support surface. For instance, the user can press downward with one or more hands or feet on stabilizing element(s) (or stabilizing members thereof), foot treatment assembly movement-generating element 110 (or receiving area and/or foot treatment element thereof, and/or the side tower(s) of the foot treatment device. The foot treatment device can thereby become secured to the support surface via the movement-inhibiting element(s) or members thereof.

The method can further comprise a user placing a foot to be treated in the receiving area. The user can then press or otherwise engage the movement-engaging mechanism of the movement-generating element to cause the housing, and thereby foot treatment element(s) to vibrate or otherwise move. For instance, the user can press the one-touch button of the movement engaging mechanism with a toe, finger, etc. In addition, the user can place a non-treating foot on a stabilizing element. For instance, the user can place a left foot on the left stabilizing element and a right foot to be treated in the receiving area on the foot treatment element(s), or vice versa.

After engaging the movement-generating element, the user can slide the foot to be treated in one or more directions (e.g., forward and backward, side-to-side, rotationally, etc.) within the receiving area and/or about the foot treatment element. A first foot treatment element can be used to exfoliate the bottom and/or sides of the treatment foot. A second foot treatment element can be used to scrub, clean, and/or brush away the exfoliated skin of the treatment foot. A third foot treatment element can be used to massage the treatment foot.

In some embodiments, the movement generating element or motor thereof can operate for a predetermined period of time. For instance, the movement generating mechanism can operate the motor (or cause the motor to operate) for at least, up to, greater than, and/or about 5 seconds, 10 seconds, 15 seconds, 20 seconds, 25 seconds, 30 seconds, 35 seconds, 40 seconds, 45 seconds, 50 seconds, 55 seconds, 60 seconds, 65 seconds, 70 seconds, 75 seconds, 80 seconds, 85 seconds, 90 seconds, 95 seconds, 100 seconds, 105 seconds, 110 seconds, 115 seconds, 120 seconds, etc. In some embodiments, the movement generating mechanism can be selectively operable for a plurality of time periods, such as by a time selection mechanism. In at least one embodiment, the movement generating mechanism can automatically disengage the movement generating element after the predetermined and/or selected period of time. In other embodiments, the movement generating element can operate until the push-button or other component of the movement generating mechanism is disengaged (or until the batteries run out).

In at least one implementation, the device can include a treatment assembly (e.g., connected to the upper surface of the base). The treatment assembly can comprise a platform having an upper surface and an opposing lower surface. The lower surface can be connected to the base and/or the upper surface can be connected to the movement-generating element. In addition, a casing can cover the movement generating element and/or be connected to the upper and/or lower surface of the platform in some embodiments. Furthermore, one or more treatment elements can be connected to or extend from the upper surface of the platform, the upper surface of the casing, and/or one or more surfaces of the movement generating element.

One or more implementations of the present disclosure include a foot treatment device comprising a body having one or more surface-stabilizing or immobilizing elements attached to a lower surface thereof and/or one or more vibrating members having to a plurality of foot treatment elements extending therefrom and/or attached to an upper surface thereof. For instance, one or more implementations of the present disclosure include a foot care device comprising a low-profile base element having one or more suction or friction members connected thereto (e.g., to a bottom surface thereof) and/or one or more foot treatment elements connected thereto (e.g., to a top surface thereof). The foot care device can also include a vibrating body having one or more foot treatment elements attached thereto and/or extending therefrom (e.g., an upper surface thereof).

Certain implementations include a personal, at-home, hands-free, and/or in-shower, foot cleaning device having a vibrating body extending upwardly from the upper surface of a base. The base also has a plurality of short, scrubbing bristles and/or an exfoliating pumice stone extending upwardly from the upper surface thereof for cleaning and caring for the bottom of the feet. The base can have opposing foot platforms extending radially or laterally therefrom for securing the device in place while in use. The base can also have one or more suction cups on the undersurface thereof to prevent movement of the device along or about the floor of the shower.

The vibrating body can have long lateral bristles extending out from the left and right sides for cleaning the tops, back, and/or sides of the feet. The vibrating body can be selectively operable with a push-bottom on/off switch (e.g., on the top of the vibrating body). The vibrating body can also have cleaning bristles extending from the front side for cleaning the fronts and between the toes of the feet. These front bristles can also clean under toe nails. The device can also include a soap or other product dispenser or cartridge that dispenses the product into the brushes or bristles such that the user does not need to bend over or lift the feet to apply soap thereto. The dispenser can also be operated by means of the on/off switch in some implementations.

Thus, in use, one can stand in the shower with the water running and tap the on/off button, engaging the device into operation. The vibrating body then begins to vibrate, which in turn vibrates the bristles or brushes extending therefrom. In some implementations, the soap dispenser can also dispense soap automatically into the bristles upon engaging the device. Alternatively, a manual foot plunger or other device can be included for soap dispensing.

The user can then place the left foot on the left foot platform to hold the device in place with the help of the bottom-mounted suction cups distributed over the underside of the base. The right foot can then be cleaned and/or treated by thrusting the right foot forward and backwards through the brushes extending from the base and vibrating body. The toes can be cleaned by rubbing them against the front-facing bristles, with particular emphasis on brushing between the toes. Both sides of the right foot can be cleaned by alternating sides of the vibrating body. The pumice stone can also be used to scrub the bottoms of the right foot, including the heels, toes, and ball of the foot.

The left foot can similarly be cleaned and treated by placing the right foot on the right foot platform and proceeding in like manner. One will appreciate that many customizable variations in foot treatment become possible with embodiments of the present disclosure described herein. For instance, the proximity of the vibrating body to the various brushes makes an in-shower, scrubbing foot massage possible without the need for sitting down, lifting the feet, or even the use of hands. The vibrating body can not only cause movement of the bristles attached thereto, but can vibrate the pumice stone and/or bristles attached to the base and/or extending therefrom. Thus, in addition to the deliberate movement of the feet to treat and cleanse, the vibrating motions can add a layer of massage, treatment, cleaning, and scrubbing to the foot care experience.

The user can perform one or more of the foregoing methods in the shower, bathroom, home, or any other suitable location. In one or more embodiments, the foot treatment device can be placed on the floor of the shower. The user can then perform the method of treating a foot while showering and/or while the water of the shower is running. Accordingly, foot treatment devices of the present disclosure can be waterproof, water resistant, and/or suitable for use in the shower. One will appreciate however that foot care devices of the present disclosure need not be used only in the shower. For instance, the foot care devices of the present disclosure can be used on any suitable support surface.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that devices, products, kits, methods, and/or processes, according to certain embodiments of the present disclosure may include, incorporate, or otherwise comprise properties, features (e.g., components, members, elements, parts, and/or portions described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

We claim:

1. A foot care device, comprising:
an electrically operable, localized movement-generating element;
a foot treatment element connected to the movement-generating element such that operation of the movement-generating element causes localized movement of the foot treatment element; and
an immobilizing element connected to the foot treatment element and adapted to inhibit positional movement of the foot treatment element.

2. The foot care device of claim 1, wherein the foot treatment element comprises a foot receiving area having an at least partially concave upper surface.

3. The foot care device of claim 2, wherein an upper surface of the foot treatment element has one or more foot treatment members disposed thereon, the one or more foot treatment members selected from the group consisting of an exfoliating member, a massaging member, and a cleansing member, wherein the exfoliating member comprises natural or synthetic pumice, the massaging member comprises an elastomeric polymer protuberance, and the cleansing member comprises bristles.

4. The foot care device of claim 1, wherein the movement-generating element comprises a motor selected from the group consisting of a vibration motor, an oscillating motor, and a reciprocating motor, the device further comprising an operating mechanism for selectively engaging the motor, the operating mechanism comprises a one-touch engaging element, the operating mechanism configured to automatically disengage the movement-generating element after a predetermined period of time.

5. The foot care device of claim 1, further comprising at least one surface stabilizing element connected to the immobilizing element, the surface stabilizing element comprising an upper surface having a non-treatment foot receiving area.

6. The foot care device of claim 1, wherein the immobilizing element comprises one or more movement-inhibiting suction members configured to adhere to a surface.

7. The foot care device of claim 1, further comprising a lower base and an upper housing connected to the base, the base having an upper surface and an opposing lower surface, the immobilizing element being connected to the lower surface, the housing being connected to the upper surface, the housing comprising an encircling wall having an exterior surface, an interior surface, and a lower edge surface extending between the exterior surface and the interior surface, the interior surface partially bounding an internal cavity, the movement-generating element being disposed within the cavity, the exterior surface having an upper receiving area, the foot treatment element being attached to the housing at the receiving area, the lower edge being connected to the upper surface of the base, the lower edge having a cavity opening therein, the base substantially covering the cavity opening.

8. The foot care device of claim 7, further comprising an attachment mechanism detachably connecting the immobilizing element to the lower surface of the base such that the base and housing connected to the base can be reversibly detached from and reattached to the immobilizing element.

9. The foot care device of claim 7, wherein the receiving area comprises an at least partially concave shape, the foot treatment element having an at least partially concave shape corresponding to the at least partially concave shape of the receiving area.

10. The foot care device of claim 9, wherein the receiving area and the foot treatment element have corresponding substantially U-shaped configurations.

11. The foot care device of claim 8, wherein the movement-generating element is mounted to the interior surface of the housing or to the upper surface of the base.

12. The foot care device of claim 8, wherein the foot treatment element comprises a detachable insert, the insert being selectively removably attached to the housing at the receiving area, the insert having an upper treatment surface and an opposing lower attachment surface, the treatment surface having a substantially U-shaped configuration and one or more foot treatment members disposed thereon, the one or more foot treatment members selected from the group consisting of an exfoliating member comprising natural or synthetic pumice, a massaging member comprising an elastomeric polymer protuberance, and a cleansing member comprising bristles, the attachment surface comprising an attachment element connecting the insert to the housing at the receiving area.

13. The foot care device of claim 12, wherein the attachment element comprises a plurality of posts extending from the attachment surface, the receiving area comprising a plurality of sockets positionally corresponding to the posts such that the posts are received within the sockets.

14. The foot care device of claim 13, wherein the receiving area further comprises a buffering element disposed between the exterior surface of the housing and the attachment surface of the insert, the buffering element adapted to reduce rattling between the housing and the insert during operation of the movement-generating element.

15. The foot care device of claim 12, wherein the insert comprises one or more drain holes extending between the treatment surface and the attachment surface, the receiving area comprising one or more drain channels extending from a first end of the receiving area to an opposing second end of the receiving area to drain water out of the receiving area.

16. The foot care device of claim 1, further comprising an inductive charge battery electrically coupled with the movement-generating element, the battery and the movement-generating element being housed within a waterproof cavity such that the movement-generating element is operable and not exposed to a liquid while being submerged in the liquid.

17. A foot care device, comprising:
a selectively engageable vibrating body having an upper surface with one or more foot treatment elements disposed thereon and an opposing lower surface with an immobilizing element disposed thereon, the immobilizing element comprising a plurality of movement-inhibiting suction members adapted to adhere to a surface and inhibit positional movement of the body about the surface, the upper surface comprises a receiving area configured for receiving a foot therein, the receiving area comprising a substantially U-shaped configuration.

18. The foot care device of claim 17, wherein the one or more foot treatment elements are selected from the group consisting of an exfoliating member comprised of natural or synthetic pumice, a massaging member comprised of a plurality of elastomeric polymer protuberance, and a cleansing member comprised of a plurality of bristles

19. The foot care device of claim 17, wherein the vibrating body comprises a lower base plate and an upper housing body, the base plate having a top plate surface and an opposing bottom plate surface, the immobilizing element being connected to the bottom plate surface, the housing body being connected to the top plate surface, the housing body comprising an encircling wall having an exterior surface, an interior surface, and a lower edge surface extending between the exterior surface and the interior surface, the interior surface partially bounding an internal cavity, the exterior surface having an upper receiving area, the upper surface being disposed in the receiving area, the lower edge surface having a cavity opening therein, the base plate substantially covering the cavity opening, the device further comprising:
a vibration motor disposed within the cavity and connected to the housing body such that operation of the motor causes vibration of the one or more foot treatment elements;
a battery element electrically coupled to the vibration motor, the battery element being disposed within the cavity; and
an engaging element for selectively engaging the motor.

20. The foot care device of claim 19, further comprising one or more water-tight sealing elements configured to enable submerged operation of the vibration motor without exposing the vibration motor or battery element to submersion fluid.

21. The foot care device of claim 19, further comprising a treatment insert removably attached to the housing body in the receiving area, the treatment insert having the upper surface and an attachment element on an opposing under surface, the attachment element connecting the treatment insert to the housing body.

22. The foot care device of claim 21, wherein the treatment insert comprises one or more drain holes extending between the upper surface and the opposing under surface, the receiving area comprises one or more drain channels extending from a first end of the receiving area to an opposing second end of the receiving area to drain water out of the receiving area.

23. A foot care kit, comprising:
an electrically operable, localized movement-generating element;
a plurality of interchangeable foot treatment elements selectively attachable to the movement-generating element such that operation of the movement-generating element causes localized movement of an attached foot treatment element; and
an immobilizing element connected to the foot treatment element and adapted to inhibit positional movement of the foot treatment element.

24. A foot care device, comprising:
a body having a concave recessed upper surface and an opposing lower surface, the upper surface having a selectively attachable foot treatment element connected thereto, the foot treatment element having a concave recessed configuration corresponding to the upper surface, the lower surface having an immobilizing element connected thereto, the immobilizing element comprising a plurality of movement-inhibiting suction members adapted to be attached to a surface and inhibit positional movement of the body about the surface, the upper surface comprises a receiving area configured for receiving a foot therein.

25. A foot care kit, comprising:
the foot care device of claim 24; and
one or more additional selectively attachable foot treatment element interchangeably connectable to the upper surface of the body.

26. A foot care device, comprising:
a lower base plate having a top plate surface and an opposing bottom plate surface;
an immobilizing element connected to the base plate and adapted to inhibit positional movement of the base plate;
an upper housing body connected to the top plate surface, the housing body comprising an encircling wall having an exterior surface, an interior surface, and a lower edge surface extending between the exterior surface and the interior surface, the interior surface partially bounding an internal cavity, the exterior surface having an upper receiving area, the lower edge surface having a cavity opening therein, the base plate substantially covering the cavity opening;
a treatment insert removably attached to the housing body in the receiving area, the treatment insert having an upper surface and an attachment element on an opposing under surface, the attachment element connecting the treatment insert to the housing body, the upper surface having one or more foot treatment elements disposed thereon;
an electrically operable, localized movement-generating element disposed within the cavity and connected to the housing body such that operation of the movement-generating element causes localized movement of the one or more foot treatment elements;
a battery element electrically coupled to the vibration motor, the battery element being disposed within the cavity;
one or more water-tight sealing elements configured to enable submerged operation of the movement-generating element without exposing the movement-generating element to water, and
an engaging element for selectively engaging the motor.
